(19) United States
(12) Patent Application Publication
(10) Pub. No.: US 2013/0202848 A1
(43) Pub. Date: Aug. 8, 2013

(54) FUNCTIONAL SHEET

(71) Applicant: SAMSUNG ELECTRONICS CO., LTD., Suwon-si (KR)

(72) Inventors: Mi Jin KIM, Suwon-si (KR); Jae Deok Lim, Hwaseong-si (KR); Jong Sung Lee, Seoul (KR); Byong Su Seol, Yongin-si (KR); Kyung Woon Jang, Suwon-si (KR)

(73) Assignee: SAMSUNG ELECTRONICS CO., LTD., Suwon-si (KR)

(21) Appl. No.: 13/755,509

(22) Filed: Jan. 31, 2013

(30) Foreign Application Priority Data
Feb. 3, 2012 (KR) 10-2012-0011216

(51) Int. Cl. H01B 7/42

(52) U.S. Cl. CPC H01B 7/421
USPC 428/141

(57) ABSTRACT

A functional sheet absorbs electromagnetic waves generated from the interior of an electronic device and efficiently transfers heat generated from an electronic component to other housings, whereby malfunction of the electronic device due to electromagnetic wave interference and overheating of the electronic component is prevented. To have these characteristics, the functional sheet includes a base including a magnetic material absorbing electromagnetic waves, a plurality of metal protrusions formed on upper and lower surfaces of the base, and a thermally conductive adhesive layer formed on portions of the upper and lower surfaces of the base in which the metal protrusions are not formed.

### CROSS-REFERENCE TO RELATED APPLICATIONS

This application claims the priority benefit of Korean Patent Application No. 10-2012-0011216, filed on Feb. 3, 2012, in the Korean Intellectual Property Office, the disclosure of which is incorporated herein by reference.

### BACKGROUND

1. Field

Embodiments disclosed herein relate to a functional sheet having excellent electromagnetic wave absorption performance and heat dissipation performance.

2. Description of the Related Art

Electronic components, such as a central processing unit (CPU), a microprocessor unit (MPU), and a large-scale integrated circuit (LSI), included in electronic devices release electromagnetic waves and thus may cause malfunction of the electronic devices due to electromagnetic wave disturbance inside the electronic devices. In addition, the electromagnetic waves are released outside of the electronic device and thus may cause a malfunction of other external electronic devices due to electromagnetic wave disturbances.

In addition, these electronic components generate a large amount of heat due to high densification and high integration, and thus, it may be necessary to transfer heat generated from the electronic components to other regions.

Accordingly, electronic devices may include an electromagnetic wave absorbing sheet and a heat dissipating sheet. A generally used electromagnetic wave absorbing sheet and heat dissipating sheet satisfactorily implement respective functions, but it may not be possible to fully implement the two functions in a region requiring both electromagnetic wave absorption and heat transfer.

For example, a sheet of a ferrite-based magnetic material having excellent electromagnetic wave absorption performance is expensive and has low flexibility. As for a sheet of a magnetic material mixed with a binder, as electromagnetic wave absorption performance increases, the thickness thereof increases and the thermal conductivity thereof decreases. Thus, it is difficult to address heat dissipation problems of electronic components.

Also, a sheet prepared by mixing magnetic material powder, thermally conductive powder, and a binder has an increased thickness in order to have sufficient electromagnetic wave absorption performance, resulting in poor heat transfer. In addition, it is difficult to apply such a sheet to thin-type products in which an allowable distance between an electronic component and a housing is very small.

### SUMMARY

Therefore, it is an aspect of the present invention to provide a functional sheet that absorbs electromagnetic waves generated in an electronic device and efficiently transfers heat generated from electronic components to other housings and thus may address problems such as malfunction of the electronic device due to electromagnetic wave disturbance and overheating of the electronic components.

In addition, the functional sheet may be formed thin and thus may be applied to thin-type products in which an allowable distance between an electronic component and a housing is very small.

Additional aspects of the invention will be set forth in part in the description which follows and, in part, will be apparent from the description, or may be learned by practice of the invention.

In accordance with one aspect of the present invention, a functional sheet includes a base including a magnetic material absorbing electromagnetic waves, a plurality of metal protrusions formed on upper and lower surfaces of the base, and a thermally conductive adhesive layer formed on portions of the upper and lower surfaces of the base in which the metal protrusions are not formed.

The metal protrusions may be formed such that the metal protrusions formed on the upper surface of the base and the metal protrusions formed on the lower surface of the base are arranged alternately with respect to each other.

The magnetic material may be any one of a metal alloy-based material and a ferrite-based material.

The magnetic material may be of a flake powder type.

The base may have a constant thickness.

The metal protrusions may be formed of at least one selected from the group consisting of solder, nickel (Ni), copper (Cu), and silver (Ag).

The thermally conductive adhesive layer may include at least one selected from the group consisting of a siloxane-based organic binder, an acryl-based organic binder, and a polyolefin-based organic binder.

The thermally conductive adhesive layer may include a paraffin-based organic binder undergoing phase transition at a specific temperature.

The thermally conductive adhesive layer may further include ceramic powder.

The ceramic powder may be any one of metal oxide powder and metal nitride powder.

In accordance with another aspect of the present invention, a functional sheet includes a base including a powder-type magnetic material absorbing electromagnetic waves, thermally conductive ceramic powder, and an adhesive binder and a plurality of metal protrusions formed on upper and lower surfaces of the base.

The magnetic material may be any one of a metal alloy-based material and a ferrite-based material.

The thermally conductive ceramic powder may be any one of metal oxide powder and metal nitride powder.

The metal oxide may be at least one selected from the group consisting of alumina, magnesia, beryllia, titania, and zirconia.

The metal nitride may be at least one of aluminum nitride and silicon nitride.

The adhesive binder may be at least one organic binder selected from the group consisting of a siloxane-based organic binder, an acryl-based organic binder, a polyolefin-based organic binder, and a paraffin-based organic binder undergoing phase transition at a specific temperature.

The metal protrusions may be formed such that the metal protrusions formed on the upper surface of the base and the metal protrusions formed on the lower surface of the base are arranged alternately with respect to each other.

The magnetic material may be of a flake powder type.

In accordance with another aspect of the present invention, a functional sheet includes a base comprising a magnetic material to absorb electromagnetic waves, a plurality of first metal protrusions formed on an upper surface of the base, spaced apart in a first direction, and a plurality of second metal protrusions formed on a lower surface of the base, spaced apart in the first direction, at positions corresponding to spaces between adjacent first metal protrusions.

The functional sheet may further include adhesive layers including a thermally conductive material, formed on portions of the upper and lower surfaces of the base, other than where the first and second metal protrusions are formed.

The base of the functional sheet may further include an organic binder, a paraffin-based material, and a ceramic powder mixed together with the magnetic material to form the base.

A curvature may be formed in the functional sheet when pressure is applied to the functional sheet in a second direction.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view illustrating a structure of a sheet prepared by mixing electromagnetic wave absorbing powder, thermally conductive powder, and a binder;

FIG. 2A is an exploded perspective view of a sheet including a magnetic material layer absorbing electromagnetic waves in a thermally conductive sheet;

FIG. 2B is a top exploded plan cross-sectional view of the sheet of FIG. 2A;

FIG. 2C is a side cross-sectional view of the sheet of FIG. 2A;

FIG. 3 is a side cross-sectional view of a sheet including a thermally conductive resin layer and an electromagnetic wave absorbing resin layer;

FIG. 4 is a side cross-sectional view of a functional sheet according to an embodiment;

FIG. 5 is a side cross-sectional view illustrating an adhesive layer including thermally conductive powder and an adhesive organic binder, according to an embodiment;

FIG. 6A is an exploded perspective view illustrating each of a plurality of layers of the functional sheet of FIG. 4;

FIG. 6B is an exploded perspective view illustrating each of a plurality of layers of the functional sheet of FIG. 4, in which the functional sheet includes metal protrusions having another shape;

FIG. 7 is a side cross-sectional view of a functional sheet according to another embodiment;

FIGS. 8A and 8B are perspective views of the functional sheet of FIG. 7;

FIG. 9 is a side cross-sectional view of a structure in which the functional sheet of FIG. 7 is installed between an electronic component and a housing inside an electronic device, according to an embodiment;

FIG. 10A is a side cross-sectional view of a base of a functional sheet according to an embodiment, in which a magnetic material included in the base is of a flake type; and

FIG. 10B is a side cross-sectional view of a base when pressure is applied to the functional sheet including the base of FIG. 10A in a vertical direction.

### DETAILED DESCRIPTION

Reference will now be made in detail to the embodiments of the present invention, examples of which are illustrated in the accompanying drawings, wherein like reference numerals refer to like elements throughout.

Hereinafter, one or more embodiments of the present invention will be described in detail with reference to the accompanying drawings.

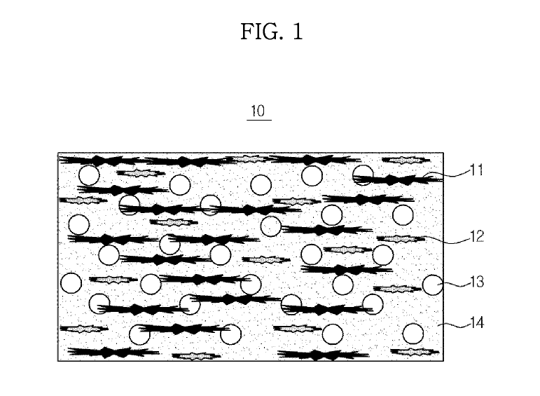

FIGS. 1 through 3 are views illustrating structures of generally used sheets. To distinctly describe the characteristics of the present invention, a detailed description of these structures is first provided and embodiments of the present invention will be described thereafter.

FIG. 1 is a view illustrating a structure of a sheet prepared by mixing electromagnetic wave absorbing powder, thermally conductive powder, and a binder.

With reference to FIG. 1, to prepare an existing functional sheet having both electromagnetic wave absorption performance and heat conduction performance, electromagnetic wave absorbing powder 11, electromagnetic wave shielding powder 12, heat conduction powder 13, and a silicon gel 14 are mixed to form a single-layered roll-type sheet 10.

The sheet 10 of FIG. 1 is the most commonly used functional sheet that absorbs electromagnetic waves and is prepared using a relatively simple manufacturing processes. To achieve sufficient electromagnetic wave absorption performance, however, the thickness of the sheet 10 must be increased and thus the sheet 10 has low heat transfer ability. In addition, there may be limitations to the application of the sheet 10 to thin-type products in which an allowable distance between an electronic component and a housing is very small.

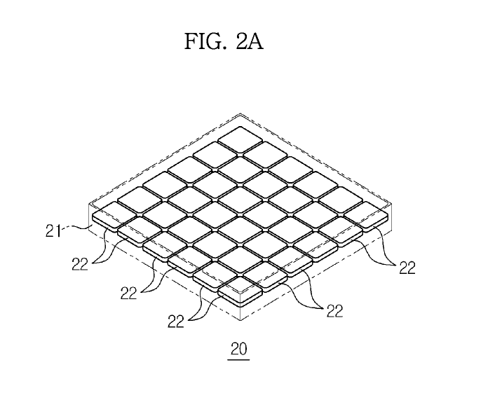

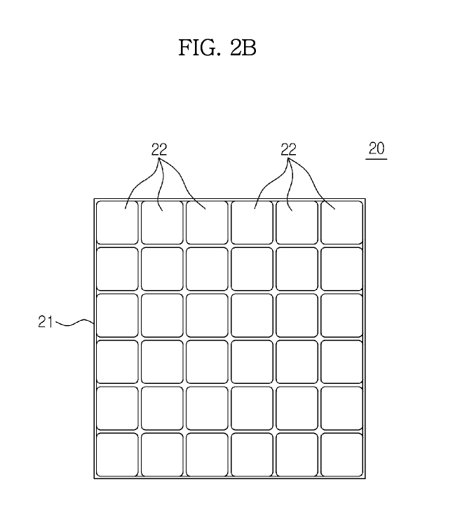

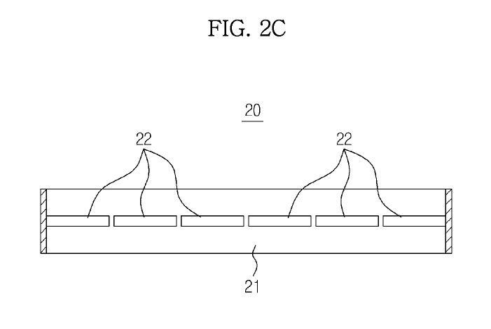

FIG. 2A is an exploded perspective view of a sheet including a magnetic material layer that absorbs electromagnetic waves in a thermally conductive sheet. FIG. 2B is a top exploded plan view of the sheet of FIG. 2A. FIG. 2C is a side cross-sectional view of the sheet of FIG. 2A.

Referring to FIGS. 2A through 2C, a sheet 20 includes a base 21 having thermal conductivity and a magnetic material layer formed in the base 21 such that a plurality of sintered ferrite flakes 22 are arranged in a horizontal direction, each sintered ferrite flake having a regular square shape.

In the sheet 20 of FIGS. 2A through 2C, the magnetic material is processed in a flake form, and thus, manufacturing processes are complicated, resulting in an increase in manufacturing costs.

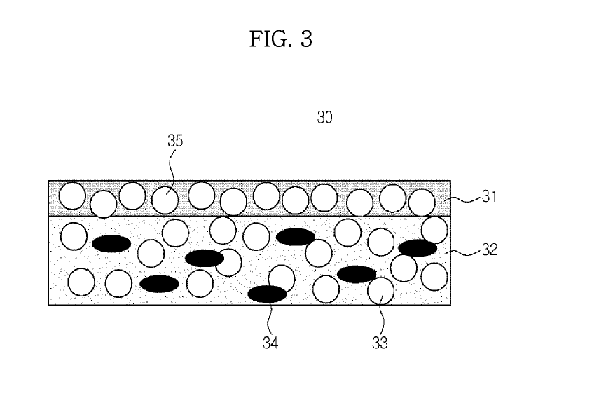

FIG. 3 is a side cross-sectional view of a sheet including a thermally conductive resin layer and an electromagnetic wave absorbing resin layer.

Referring to FIG. 3, an adhesive tape 30, which is an existing sheet, includes a porous polymer resin layer 32 including thermally conductive fillers 33 and nitrogen bubbles 34 and a resin layer 31 including electromagnetic wave absorbing fillers 35.

The thickness of the adhesive tape 30 of FIG. 3 is also large, and thus, there is limitation in interposing the adhesive tape 30 between an electronic component and a housing.

To address problems of the sheets having the structures illustrated in FIGS. 1 through 3, a functional sheet according to an embodiment of the present invention may have excellent electromagnetic wave absorption performance and heat conduction performance and be formed to have a small thickness.

Hereinafter, a structure of a functional sheet according to an embodiment of the present invention will be described.

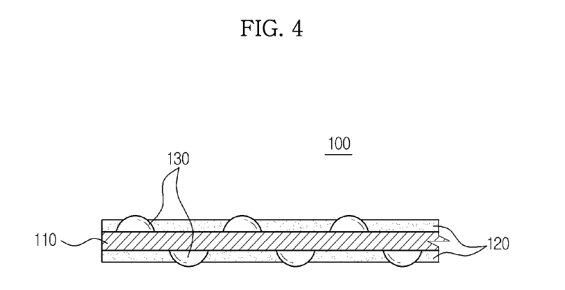

FIG. 4 is a side cross-sectional view of a functional sheet 100 according to an embodiment.

Referring to FIG. 4, the functional sheet 100 includes a base 110 having electromagnetic wave absorption performance, metal protrusions 130 formed on upper and lower surfaces of the base 110, and adhesive layers 120 interposed between the metal protrusions 130. That is, the adhesive layers may be formed on portions of the upper and lower surfaces of the base 110 in which the metal protrusions 130 are not formed.

The base 110 may be formed of a material having electromagnetic wave absorption performance and formed to a uniform thickness. Here, the material having electromagnetic wave absorption performance may be a magnetic material. For example, the base 110 of the functional sheet 100 may include any one of a metal alloy-based material and a ferrite-based material.

The metal alloy-based material and the ferrite-based material have magnetism, and thus, when the base 110 of the functional sheet 100 is formed of a metal alloy-based material or a ferrite-based material, the functional sheet 100 has electromagnetic wave absorption performance.

In an embodiment, the metal alloys may include an F—Si—Al alloy, an Fe—Si alloy, an Fe—Si—Cr alloy, a Ni—Fe alloy, an Fe—Ni—Si alloy, and a Ni—Fe—Mo alloy.

Ferrites collectively refer to ferromagnetic ceramic compounds, and may be classified as soft ferrites and hard ferrites according to their magnetic characteristics. In embodiments of the present invention, any ferrite-based magnetic materials may be used. For example, the ferrite-based material may include Ni—Zn-based ferrites, Mn—Ni-based ferrites, Mg—Zn-based ferrites, and the like, and ferrite-based metal oxides may be used as a magnetic material.

Also, the base 110 of the functional sheet 100 may include at least two magnetic materials. The at least two magnetic materials may be the same, i.e., metal alloys or ferrites, or may be different. For example, the at least two magnetic materials may be two metal-alloy based materials from among a Fe—Si—Al alloy, an Fe—Si alloy, an Fe—Si—Cr alloy, a Ni—Fe alloy, an Fe—Ni—Si alloy, and a Ni—Fe—Mo alloy. Alternatively, the at least two magnetic materials may be two ferrite-based materials from among Ni—Zn-based ferrites, Mn-Ni-based ferrites, Mg—Zn-based ferrites, and the like, and ferrite-based metal oxides. Alternatively, the at least two magnetic materials may be different and include one metal-alloy based material and one ferrite-based material.

As illustrated in FIG. 4, the metal protrusions 130 are formed on the upper and lower surfaces of the base 110, and the metal protrusions 130 formed on the upper surface of the base 110 and the metal protrusions 130 formed on the lower surface of the base 110 are arranged alternately with respect to each other in a horizontal direction.

One reason for adopting such a configuration is that when pressure is applied in a vertical direction to a structure in which the functional sheet 100 is installed between a housing and an electronic component, a curvature is formed based on the metal protrusions 130. Accordingly, the functional sheet 100 may have improved electromagnetic wave absorption performance and a small thickness. A detailed description thereof will be given below.

The metal protrusions 130 may be formed of a metal material, such as solder, nickel (Ni), copper (Cu), or silver (Ag) and thus are not flattened or warped under pressure. However, embodiments of the present invention are not limited to the above-listed metal materials, and any metal material may be used to form the metal protrusions 130.

As shown in FIG. 4, the metal protrusions 130 are formed on both upper and lower surfaces of the base 110, and may have a same shape and same size. However, the metal protrusions 130 on an upper surface may have a different shape and/or size than the metal protrusions on the lower surface. Alternatively, the metal protrusions 130 on the upper and/or lower surface may not have a uniform shape and/or size.

The adhesive layers 120 may be formed on respective opposite surfaces of the base 110. In particular, the adhesive layers 120 may be formed on portions of the opposite surfaces of the base 110 in which the metal protrusions 130 are not formed.

The adhesive layer 120 may include an adhesive polymer, for example, an organic binder such as a siloxane-based binder, an acryl-based binder, or a polyolefin-based binder and may further include a paraffin-based material which undergoes phase transition from a solid to liquid at a specific temperature or higher. Here, the specific temperature may range from about 45 to about 65° C., but is not limited thereto.

When the adhesive layer 120 includes the paraffin-based material which undergoes a phase transition from a solid to liquid at a specific temperature or higher, fluidity of the functional sheet 100 is increased by the heat generated from electronic components and thus the functional sheet 100 may smoothly fill a gap between an electronic component and a housing even in a region in which surface unevenness is formed.

In the functional sheet 100, the adhesive layer 120 may include one or more adhesive polymers.

However, the kinds of adhesive polymers disclosed herein are not limited thereto, and various other adhesive polymers may be used.

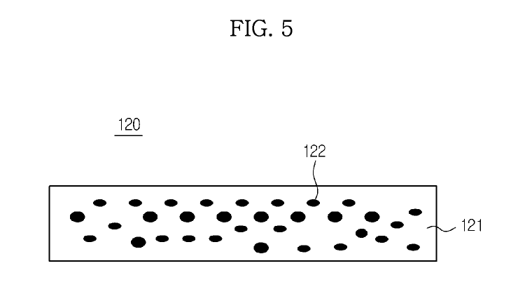

The adhesive layer 120 may further include a thermally conductive material, in addition to the adhesive polymer. FIG. 5 is a side cross-sectional view illustrating a structure of the adhesive layer 120 of FIG. 4 including thermally conductive powder and an adhesive organic binder.

Referring to FIG. 5, the adhesive layer 120 of the functional sheet 100 may further include a powder-type thermally conductive material 122, in addition to an adhesive organic binder 121. The thermally conductive material 122 may be ceramic powder. In particular, the thermally conductive material 122 may be a metal oxide such as alumina, magnesia, beryllia, titania, or zirconia or a metal nitride such as aluminum nitride or silicon nitride.

As illustrated in FIG. 5, when the adhesive layer 120 includes the thermally conductive material 122, the functional sheet 100 has improved heat conduction performance. In addition, since the thermally conductive material 122 is included in the thin adhesive layer 120 without forming a separate thermally conductive layer, the functional sheet 100 may have a small thickness.

However, embodiments of the present invention are not limited to the above-described thermally conductive materials, and various other thermally conductive materials may be used.

In addition, it is illustrated in FIG. 4 that the adhesive layers 120 are formed to such a thickness that the height of the adhesive layers 120 is less than that of the metal protrusions 130. In some embodiments, however, it may be possible that the thickness of the adhesive layers 120 is equal to or greater than that of the metal protrusions 130.

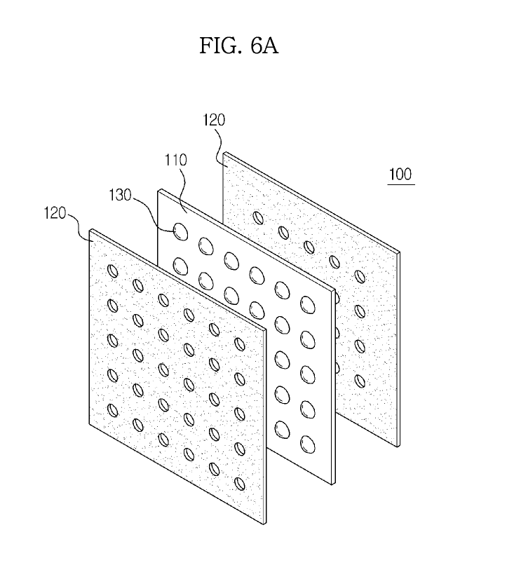

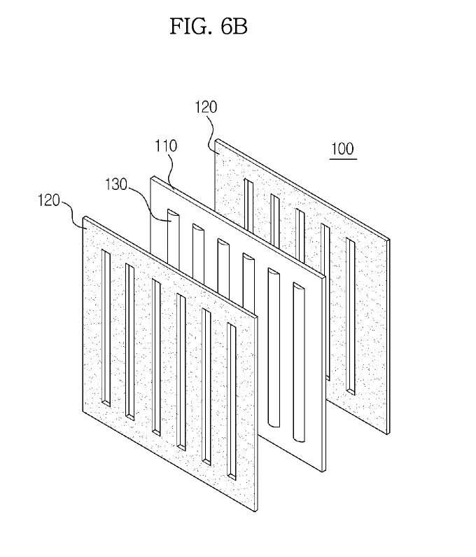

FIG. 6A is an exploded perspective view of each of a plurality of layers of the functional sheet 100 of FIG. 4. FIG. 6B is an exploded perspective view of each of a plurality of layers of a functional sheet including metal protrusions having another shape.

As illustrated in FIG. 6A, the metal protrusions 130 may be formed on opposite surfaces of the base 110 and have a hemispherical shape. However, the shape of the metal protrusions 130 is not limited thereto. For example, the metal protrusions 130 may have a dome shape similar to the hemispherical shape.

Also, as illustrated in FIG. 6B, the metal protrusions, which are also designated by reference numeral 130, may be formed on opposite surfaces of the base 110 and have a hemicylindrical shape. As in the case of the metal protrusions 130 illustrated in FIG. 6A, the shape of the metal protrusions 130 is not limited thereto. For example, the metal protrusions 130 may have a curved surface shape similar to the hemicylindrical shape.

The metal protrusions 130 may be formed by printing a paste of a metal-based material such as solder, Ni, Cu, or Ag on the base 110 and curing the paste thereof. However, the method of forming the metal protrusions 130 is not limited thereto, and any method known in the art used to form a protrusion may be used.

The shapes of the metal protrusions 130 illustrated in FIGS. 6A and 6B are not limited to the above-described shapes, and the metal protrusions 130 may have various other shapes. That is, the metal protrusions 130 may have any shape (i.e., other shapes including the curved surface shape) so long as the metal protrusions 130 cause a curvature of the functional sheet 100 when pressure is applied thereto. For example, each of the metal protrusions 130 formed on a side may have different shapes and/or sizes from one another.

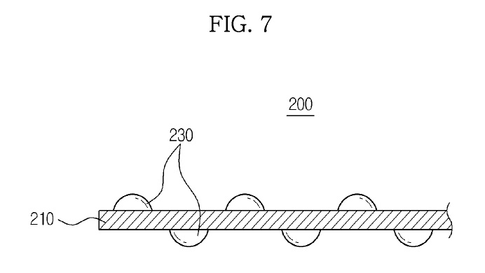

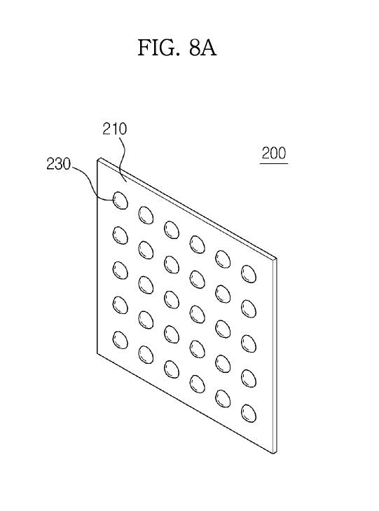

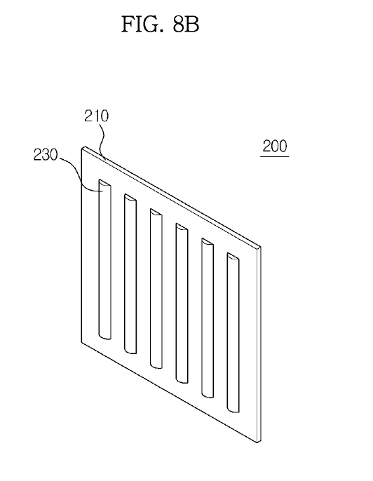

The structure of the functional sheet 100 has been described. Hereinafter, a structure of a functional sheet according to another embodiment will be described with reference to FIGS. 7 and 8.

FIG. 7 is a side cross-sectional view of a functional sheet 200 according to another embodiment.

Referring to FIG. 7, the functional sheet 200 includes a base 210 formed by mixing a magnetic material, a thermally conductive material, and an adhesive material and metal protrusions 230. Here, the adhesive material acts as a binder.

Unlike the functional sheet 100 separately including the adhesive layers 120 including a thermally conductive material and an adhesive material and the base 110 including a magnetic material, the functional sheet 200 includes the base 210 including the magnetic material, the thermally conductive material, and the adhesive material, and thus, the functional sheet 200 including the base 210 has an electromagnetic wave absorption property, thermal conductivity, and an adhesive property without separately including a thermally conductive adhesive layer.

Also, as illustrated in FIG. 7, the functional sheet 200 includes metal protrusions 230 formed on upper and lower surfaces of the base 210 such that the metal protrusions 230 formed on the upper surface of the base 210 and the metal protrusions 230 formed on the lower surface of the base 210 are arranged alternately with respect to each other. Accordingly, when pressure is applied to the functional sheet 200 in a vertical direction, a curvature is formed in the functional sheet 200.

FIGS. 8A and 8B are perspective views of the functional sheet 200 of FIG. 7.

As in the functional sheet 100 of FIG. 4, the metal protrusions 230 may be formed on the base 210 and have a hemispherical shape as illustrated in FIG. 8A, and the metal protrusions 230 may be formed on the base 210 and have a hemicylindrical shape as illustrated in FIG. 8B.

However, the shapes of the metal protrusions 230 are not limited to the shapes illustrated in FIGS. 8A and 8B. That is, the metal protrusions 230 may have any shape so as to cause a curvature of the functional sheet 200 when pressure is applied to the functional sheet 200, as described below.

The functional sheet 200 may be formed of the above-listed materials used in the functional sheet 100. In particular, the magnetic material included in the base 210 may be a metal alloy-based material or a ferrite-based material. Examples of the metal alloy-based material include an Fe—Si—Al alloy, an Fe—Si alloy, an Fe—Si—Cr alloy, a Ni—Fe alloy, an Fe—Ni—Si alloy, and a Ni-Fe-Mo alloy. Examples of the ferrite-based material include Ni—Zn-based ferrites, Mn—Ni-based ferrites, and Mg—Zn-based ferrites.

In addition, the base 210 may include at least two magnetic materials. The at least two magnetic materials may be the same, i.e., metal alloys or ferrites, or different. For example, the at least two magnetic materials may be two metal-alloy based materials from among a Fe—Si—Al alloy, an Fe—Si alloy, an Fe—Si—Cr alloy, a Ni—Fe alloy, an Fe—Ni—Si alloy, and a Ni—Fe—Mo alloy. Alternatively, the at least two magnetic materials may be two ferrite-based materials from among Ni—Zn—based ferrites, Mn—Ni-based ferrites, Mg—Zn-based ferrites, and the like, and ferrite-based metal oxides. Alternatively, the at least two magnetic materials may be different and include one metal-alloy based material and one ferrite-based material.

The adhesive material may be an organic binder such as a siloxane-based binder, an acryl-based binder, or a polyolefin-based binder, and the base 210 may further include a paraffin-based material which undergoes phase transition from solid to liquid at a specific temperature or higher. Here, the specific temperature may range from about 45 to about 65° C., but is not limited thereto.

When the base 210 further includes the paraffin-based material, fluidity of the functional sheet 200 is increased by heat generated from electronic components and thus the functional sheet 200 may smoothly fill a gap between an electronic component and a housing even in a region in which surface unevenness is formed. Therefore, reduction in heat conduction performance may be prevented.

The base 210 of the functional sheet 200 may include one or more adhesive materials.

The thermally conductive material included in the base 210 may be ceramic powder. In particular, the thermally conductive material may be a metal oxide such as alumina, magnesia, beryllia, titania, or zirconia or a metal nitride such as aluminum nitride or silicon nitride.

The metal protrusions 230 may be formed of a metal material, such as solder, Ni, Cu, or Ag and thus are not flattened or warped under pressure. However, embodiments of the present invention are not limited to the above-listed metal materials, and various other metal materials may be used to form the metal protrusions 230.

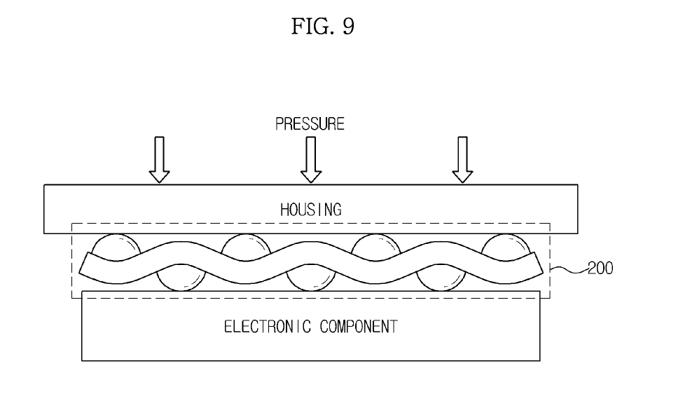

The structure of the functional sheet 200 according to the embodiment of the present invention has been described. Hereinafter, particular functions and effects of the functional sheet 200 will be described with reference to FIG. 9.

FIG. 9 is a side cross-sectional view of a structure in which the functional sheet 200 is installed between an electronic component and a housing inside an electronic device. The functional sheet 200 is applied to the embodiment of FIG. 9, but the same is the case for the functional sheet 100.

Referring to FIG. 9, since the functional sheet 200 is disposed between the electronic component and the housing inside the electronic device, heat generated from the electronic component may be transferred to other regions and the functional sheet 200 may absorb electromagnetic waves released from the electronic component.

In this regard, to install the functional sheet 200, the housing may be pressurized. When pressure in a vertical direction is transferred via the housing, a curvature is formed in the functional sheet 200. As described above, formation of the curvature is caused by the metal protrusions 230 formed on upper and lower surfaces of the functional sheet 200 such that the metal protrusions 230 formed on the upper surface thereof and the metal protrusions 230 formed on the lower surface thereof are arranged alternately with respect to each other. To facilitate the formation of the curvature, as illustrated in FIGS. 4, 7, and 9, the metal protrusions 230 formed on the upper surface thereof may be spaced apart from the metal protrusions 230 formed on the lower surface thereof at a constant interval or more in a horizontal direction. As another example, when the metal protrusions are arranged in a grid-like pattern as shown, for example, in FIG. 8A, the metal protrusions may be spaced apart in constant intervals in both horizontal and vertical directions on a first surface. The metal protrusions may be spaced apart in constant intervals in both horizontal and vertical directions on the second surface, aligned between the space between the intervals of the metal protrusions on the first surface.

As illustrated in FIG. 9, when the base 210 is curved or bent, the thickness of the functional sheet 200 decreases and heat conduction is satisfactorily implemented. As can be seen from FIG. 9, the base 210 may have a sinusoidal or oscillating shape in a horizontal direction. Here, the thickness of the functional sheet 200 may be about 0.2 mm or less.

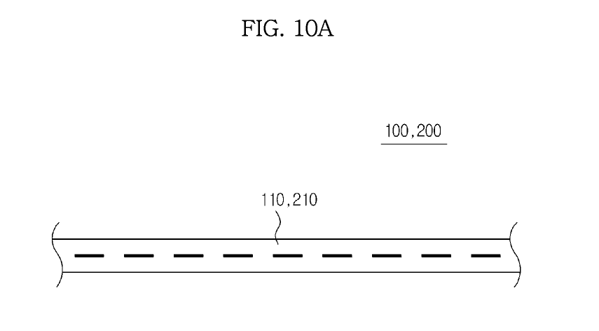

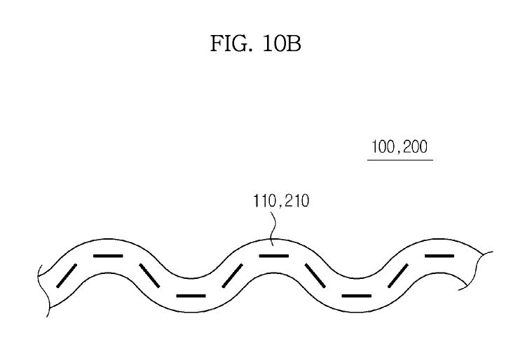

In addition, the curvature of the base 210 improves electromagnetic wave absorption performance. In particular, while a sheet having no curvature predominantly absorbs vertical (longitudinal) electromagnetic waves, the functional sheet 200 having a curvature is able to absorb even transverse electromagnetic waves. Particularly, when the magnetic material included in the base 210 is of a flake powder type, the electromagnetic wave absorption performance is improved. Hereafter, this will be described in detail with reference to FIG. 10.

FIG. 10A is a side cross-sectional view of the base 110 or 210 of the functional sheet 100 or 200 which includes a flake-type magnetic material. FIG. 10B is a side cross-sectional view of the base 110 or 210 when pressure is applied to the functional sheet 100 or 200 including the base 110 or 210 in a vertical direction.

As illustrated in FIG. 10A, when the magnetic material included in the base 110 or 210 is of a flake type, flakes of the magnetic material are all arranged in a horizontal direction before pressure is applied to the functional sheet 100 or 200.

Meanwhile, when pressure is applied to the base 110 or 210 in a vertical direction, the base 110 or 210 has a curvature and the magnetic material flakes are arranged in both horizontal and vertical directions, as illustrated in FIG. 10B. The magnetic material flakes arranged in a horizontal direction absorb a longitudinal electromagnetic wave and the magnetic material flakes arranged in a vertical direction absorb a transverse electromagnetic wave.

Thus, when the base 110 or 210 is formed of a flake-type magnetic material, the base 110 or 210 may absorb other directional electromagnetic waves as well as the longitudinal electromagnetic wave and a direction of absorbed electromagnetic wave may be controlled by adjusting a degree of curvature formed at the base 110 or 210.

In the above-described embodiments, the functional sheet 100 or 200 is installed between a housing and an electronic component. However, embodiments of the present invention are not limited thereto. That is, the functional sheet 100 or 200 may be disposed at any position in which heat conduction and heat dissipation are needed.

As is apparent from the above description, a functional sheet absorbs electromagnetic waves generated from the interior of an electronic device and efficiently transfers heat generated from an electronic component to other housings, whereby malfunction of the electronic device due to electromagnetic wave interference and overheating of the electronic component may be prevented.

In addition, the functional sheet may have a small thickness and thus may be applied to thin-type products in which an allowable distance between an electronic component and a housing is very small.

Although a few example embodiments of the present invention have been shown and described, it would be appreciated by those skilled in the art that changes may be made to these embodiments without departing from the principles and spirit of the invention, the scope of which is defined in the claims and their equivalents.

What is claimed is:

1. A functional sheet comprising:
a base comprising a magnetic material to absorb electromagnetic waves;
a plurality of metal protrusions formed on upper and lower surfaces of the base; and
a thermally conductive adhesive layer formed on portions of the upper and lower surfaces of the base, wherein the metal protrusions are not formed on the portions.

2. The functional sheet according to claim 1, wherein metal protrusions are formed such that the metal protrusions formed on the upper surface of the base and the metal protrusions formed on the lower surface of the base are arranged alternately with respect to each other.

3. The functional sheet according to claim 1, wherein the magnetic material is any one of a metal alloy-based material and a ferrite-based material.

4. The functional sheet according to claim 1, wherein the magnetic material is of a flake powder type.

5. The functional sheet according to claim 1, wherein the base has a constant thickness.

6. The functional sheet according to claim 1, wherein the metal protrusions comprise at least one material selected from the group consisting of solder, nickel (Ni), copper (Cu), and silver (Ag).

7. The functional sheet according to claim 1, wherein the thermally conductive adhesive layer comprises at least one binder selected from the group consisting of a siloxane-based organic binder, an acryl-based organic binder, and a polyolefin-based organic binder.

8. The functional sheet according to claim 1, wherein the thermally conductive adhesive layer comprises a paraffin-based organic binder which undergoes a phase transition at a specific temperature.

9. The functional sheet according to claim 7, wherein the thermally conductive adhesive layer further comprises ceramic powder.

10. The functional sheet according to claim 9, wherein the ceramic powder is any one of a metal oxide powder and metal nitride powder.

11. The functional sheet according to claim 8, wherein the thermally conductive adhesive layer further comprises ceramic powder.

12. The functional sheet according to claim 11, wherein the ceramic powder is any one of a metal oxide powder and metal nitride powder.

13. A functional sheet comprising:
a base comprising a powder-type magnetic material to absorb electromagnetic waves, thermally conductive ceramic powder, and an adhesive binder; and
a plurality of metal protrusions formed on upper and lower surfaces of the base.

14. The functional sheet according to claim 13, wherein the magnetic material is any one of a metal alloy-based material and a ferrite-based material.

15. The functional sheet according to claim 13, wherein the thermally conductive ceramic powder is any one of a metal oxide powder and metal nitride powder.

16. The functional sheet according to claim 15, wherein the metal oxide comprises at least one metal oxide selected from the group consisting of alumina, magnesia, beryllia, titania, and zirconia.

17. The functional sheet according to claim 15, wherein the metal nitride is at least one of aluminum nitride and silicon nitride.

18. The functional sheet according to claim 13, wherein the adhesive binder comprises at least one organic binder selected from the group consisting of a siloxane-based organic binder, an acryl-based organic binder, a polyolefin-based organic binder, and a paraffin-based organic binder undergoing phase transition at a specific temperature.

19. The functional sheet according to claim 13, wherein the metal protrusions are formed such that the metal protrusions formed on the upper surface of the base and the metal protrusions formed on the lower surface of the base are arranged alternately with respect to each other.

20. The functional sheet according to claim 13, wherein the magnetic material is of a flake powder type.

21. A functional sheet comprising:
a base comprising a magnetic material to absorb electromagnetic waves;
a plurality of first metal protrusions formed on an upper surface of the base, spaced apart in a first direction; and
a plurality of second metal protrusions formed on a lower surface of the base, spaced apart in the first direction, at positions corresponding to spaces between adjacent first metal protrusions.

22. The functional sheet according to claim 21, further comprising adhesive layers including a thermally conductive material, formed on portions of the upper and lower surfaces of the base, other than where the first and second metal protrusions are formed.

23. The functional sheet according to claim 21, wherein the base further comprises an organic binder, a paraffin-based material, and a ceramic powder mixed together with the magnetic material to form the base.

24. The functional sheet according to claim 21, wherein a curvature is formed in the functional sheet when pressure is applied to the functional sheet in a vertical direction.
